(19) United States
(12) Patent Application Publication
(10) Pub. No.: US 2025/0307470 A1
(43) Pub. Date: Oct. 2, 2025

(54) INFORMATION MANAGEMENT SYSTEM, INFORMATION MANAGEMENT METHOD, AND RECORDING MEDIUM

(71) Applicant: Panasonic Automotive Systems Co., Ltd., Kanagawa (JP)

(72) Inventors: Akihito TAKEUCHI, Osaka (JP); Kaoru YOKOTA, Hyogo (JP); Takumaru NAGAI, Osaka (JP)

(73) Assignee: Panasonic Automotive Systems Co., Ltd., Kanagawa (JP)

(21) Appl. No.: 19/079,077

(22) Filed: Mar. 13, 2025

(30) Foreign Application Priority Data
Mar. 28, 2024 (JP) 2024-053571

(51) Int. Cl. G06F 21/62; G06V 40/16

(52) U.S. Cl. CPC G06F 21/629; G06V 40/172

(57) ABSTRACT

An information management system includes: an obtainer that obtains an identification information item of a driver operating the mobile body; an application programming interface (API) library that stores, in association with each other, one or more identification information items of one or more drivers and one or more lists of APIs that are capable of being called; and an API controller. The API controller: obtains an API information item related to an API for accessing an information item stored in the mobile body, the API being an API scheduled to be called by software executed in the mobile body; determines whether the API related to the API information item is capable of being called, by referencing the API library using the identification information item of the driver operating the mobile body and the API information item obtained; and calls the API based on a determination result.

### CROSS REFERENCE TO RELATED APPLICATION

The present application is based on and claims priority of Japanese Patent Application No. 2024-053571 filed on Mar. 28, 2024.

### FIELD

The present disclosure relates to an information management system, an information management method, and a recording medium.

### BACKGROUND

In recent years, information terminals, such as smartphones and the like have enjoyed widespread adoption, and with the use of such information terminals, a stage has been reached where even greater convenience is now demanded. For example, Patent Literature (PTL) 1 describes an invention that allows for website browsing using a smartphone web browser and the easy installation of applications (also referred to hereinafter as “apps”) in conjunction with such website browsing.

At the same time, the provision of services for providing comfort in vehicle cabins by allowing for the installation of such apps and the execution of such apps in mobile bodies, such as automobiles and the like, in the same manner as in information terminals, such as smartphones and the like, is increasing. Furthermore, automobiles referred to as software defined vehicles (SDV) in which software can be updated by wireless communication (such as by over the air (OTA) means, for example) have been introduced, and opportunities to use software in automobiles and the like are also increasing.

### CITATION LIST

### Patent Literature

PTL 1: Japanese Unexamined Patent Application Publication No. 2019-125033

### SUMMARY

However, an improvement can be made in such mobile bodies, such as automobiles and the like from an information management standpoint. In view of this, the present disclosure provides an information management system and the like that can allow for further improvement in such mobile bodies.

An information management system according to one aspect of the present disclosure is an information management system that manages information stored in a mobile body, and the information management system includes: an obtainer that obtains an identification information item of a driver operating the mobile body; a function library that stores, in association with each other, one or more identification information items of one or more drivers and one or more lists of functions that are capable of being called, the one or more identification information items including the identification information item, the one or more drivers including the driver; and a function controller, wherein the function controller: obtains a function information item related to a function for accessing an information item stored in the mobile body, the function being a function scheduled to be called by software executed in the mobile body; determines whether the function related to the function information item is capable of being called, by referencing the function library using the identification information item of the driver operating the mobile body obtained and the function information item obtained; and calls the function based on a determination result obtained by the function controller.

An information management method according to one aspect of the present disclosure is an information management method for managing information stored in a mobile body and is executed by a computer, and the information management method includes: obtaining an identification information item of a driver operating the mobile body; obtaining a function information item related to a function for accessing an information item stored in the mobile body, the function being a function scheduled to be called by software executed in the mobile body; determining whether the function related to the function information item is capable of being called, by referencing a function library that stores, in association with each other, one or more identification information items of one or more drivers and one or more lists of functions that are capable of being called, using the identification information item of the driver operating the mobile body obtained and the function information item obtained, the one or more identification information items including the identification information item, the one or more drivers including the driver; and calling the function based on a result of the determining.

A storage medium according to one aspect of the present disclosure is a non-transitory computer-readable recording medium having recorded thereon a program for causing a computer to execute the above-mentioned information management method.

It should be noted that these general and specific aspects may be implemented as a device, an integrated circuit, a computer program, or a non-transitory computer-readable recording medium such as a CD-ROM, or may be implemented as any combination of a device, an integrated circuit, a computer program, and a recording medium.

In view of this, the information management system according to one aspect of the present disclosure can allow for further improvement in such mobile bodies.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram of a functional configuration of an information management system according to an embodiment.

FIG. 2 is a diagram for describing information stored in an API library according to the embodiment.

FIG. 3 is a diagram for describing information stored in a vehicle according to the embodiment.

FIG. 4 is a flowchart illustrating one example of operation of the information management system according to the embodiment.

### DESCRIPTION OF EMBODIMENTS

### Outline of Present Disclosure

In relation to the technique described in the “Background” section, the inventors have found the following point to be problematic. The usage patterns of mobile bodies, such as automobiles and the usage patterns of smartphones, are different from each other and this is problematic from an information management standpoint. In other words, from the perspective of the above-mentioned problematic point, in mobile bodies, the provision of an information management system or the like that can more appropriately manage information is desired. More specifically, as described in the “Background” section, services for providing comfort in vehicle cabins by allowing for the installation of apps and the execution of such apps in mobile bodies, such as automobiles and the like, in the same manner as in information terminals, such as smartphones and the like, are increasingly being provided. Furthermore, although opportunities to browse websites using web browsers are likely to further increase even in automobiles and the like, when applying the techniques described in the above-mentioned PTL 1 to an automobile, a point to consider is that there are cases where mobile bodies, such as automobiles are shared among a plurality of users, such as family members and friends unlike with smartphones. In particular, there are even situations, such as in car sharing and the like, where a large number of unspecified users are using the same automobile. For this reason, in some cases, the information management methods used in information terminals, such as smartphones and the like that belong to an individual would be inadequate in managing sensitive settings related to websites and security settings and the like related to app installations. Furthermore, unlike in a smartphone and the like, for which the capability of constant connectivity to a network, such as the Internet, is assumed, in a mobile body, there are cases where the Internet cannot be accessed depending on the location in which the mobile body is being driven. Consequently, it can be considered that improvements can be made not only in how information on a web server is managed, but in how information in a vehicle itself is managed as well.

The present disclosure has been conceived in view of the above, and provides an information management system and the like that can more appropriately manage information in a mobile body.

An outline of the present disclosure is described hereinafter.

An information management system according to a first aspect of the present disclosure is an information management system that manages information stored in a mobile body, and the information management system includes: an obtainer that obtains an identification information item of a driver operating the mobile body; an application programming interface (API) library that stores, in association with each other, one or more identification information items of one or more drivers and one or more lists of APIs that are capable of being called, the one or more identification information items including the identification information item, the one or more drivers including the driver; and an API controller. The API controller: obtains an API information item related to an API for accessing an information item stored in the mobile body, the API being an API scheduled to be called by software executed in the mobile body; determines whether the API related to the API information item is capable of being called, by referencing the API library using the identification information item of the driver operating the mobile body obtained and the API information item obtained; and calls the API based on a determination result obtained by the API controller.

According to such an information management system, since the driver and a list of APIs capable of being called are stored in association with each other in the API library, it can be determined whether the API is an API capable of being called for the driver by referencing the list of APIs that corresponds to the driver after the driver has been identified. For example, even for newly installed software, by determining if an API is capable of being called for each driver, it can be determined whether to call the API being called by the software without needing to configure additional settings or the like, and access to information items stored in the mobile body can be controlled by the process executed by calling the API. Consequently, the information items can be managed in a more appropriate manner.

Furthermore, an information management system according to a second aspect of the present disclosure is the information management system according to the first aspect, in which the identification information item of the driver operating the mobile body is obtained as a result of personal identification using an image obtained capturing the driver.

Accordingly, it can be determined whether the API related to the API information item is capable of being called by referencing the API library using the identification information item of the driver operating the mobile body obtained as a result of personal identification using the image obtained by capturing the driver.

Furthermore, an information management system according to a third aspect of the present disclosure is the information management system according to the first aspect, in which the identification information item of the driver operating the mobile body is obtained as a result of personal identification using communication with an identification device possessed by the driver.

Accordingly, it can be determined whether the API related to the API information item is capable of being called by referencing the API library using the identification information item of the driver operating the mobile body obtained as a result of personal identification using communication with the identification device possessed by the driver.

Furthermore, an information management system according to a fourth aspect of the present disclosure is the information management system according to any one of the first aspect to the third aspect, in which an API information item is obtained for each scheduled call of an API by software executed in the mobile body, and each time an API information item is obtained, the API controller determines whether an API related to the API information item is capable of being called, and calls the API based on a determination result obtained by the API controller.

Accordingly, it can be determined whether the API related to the API information item is capable of being called by referencing the API library using the API information item obtained for each scheduled instance of a call of the API by software executed in the mobile body.

Furthermore, an information management system according to a fifth aspect of the present disclosure is the information management system according to any one of the first aspect to the fourth aspect, in which the identification information item of the driver operating the mobile body is obtained for each scheduled call of an API by software executed in the mobile body, and the API controller references the API library using an identification information item of a driver operating the mobile body that is newly obtained.

Accordingly, it can be determined whether the API related to the API information item is capable of being called by referencing the API library using the identification information item of the driver operating the mobile body obtained for each scheduled instance of a call of the API by software executed in the mobile body.

Furthermore, an information management system according to a sixth aspect of the present disclosure is the information management system according to any one of the first aspect to the fourth aspect, in which the identification information item of the driver operating the mobile body is obtained after the mobile body is started, and the API controller continues to use the identification information item obtained until the driver operating the mobile body leaves a seat.

Accordingly, it can be determined whether the API related to the API information item is capable of being called by referencing the API library by the continued use of the identification information item of the driver operating the mobile body obtained after the mobile body has been started until the driver leaves the seat.

Furthermore, an information management method according to a seventh aspect of the present disclosure is an information management method for managing information stored in a mobile body and is executed by a computer, and the information management method includes: obtaining an identification information item of a driver operating the mobile body; obtaining an application programming interface (API) information item related to an API for accessing an information item stored in the mobile body, the API being an API scheduled to be called by software executed in the mobile body; determining whether the API related to the API information item is capable of being called, by referencing an API library that stores, in association with each other, one or more identification information items of one or more drivers and one or more lists of APIs that are capable of being called, using the identification information item of the driver operating the mobile body obtained and the API information item obtained, the one or more identification information items including the identification information item, the one or more drivers including the driver; and calling the API based on a result of the determining.

Accordingly, the same advantageous effects as the above-mentioned information management system can be achieved.

Furthermore, a recording medium according to an eighth aspect of the present disclosure is a non-transitory computer-readable recording medium having recorded thereon a program for causing a computer to execute the information management method according to the seventh aspect.

Accordingly, by causing the computer to execute the program, the same advantageous effects as the above-mentioned information management method can be achieved.

It should be noted that these general and specific aspects may be implemented as a device, an integrated circuit, a computer program, or a non-transitory computer-readable recording medium such as a CD-ROM, or may be implemented as any combination of a device, an integrated circuit, a computer program, and a recording medium.

Hereinafter, embodiments will be described in detail by referring to the drawings as needed. However, there are instances where excessively detailed descriptions may be omitted. For example, detailed descriptions of well-known matters or repeated descriptions of elements that are essentially the same may be omitted. This is to make the following descriptions easier to understand for those skilled in the art and to avoid redundancy.

Note that the inventors of the present application provide the accompanying figures and the following descriptions not to limit the scope of the claims, but to aid those skilled in the art to adequately understand the present disclosure.

### Embodiment

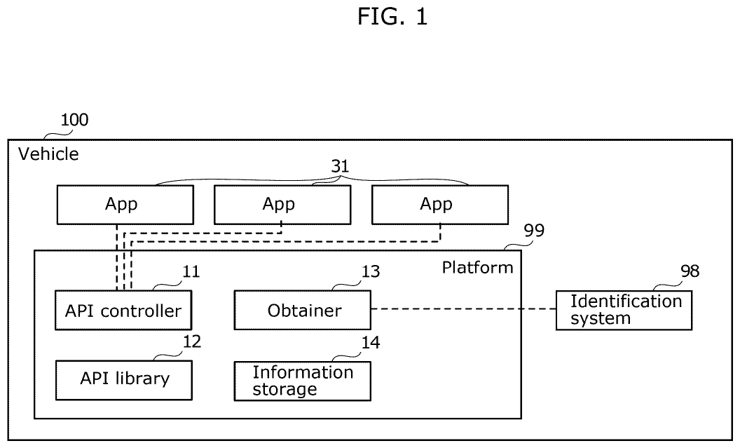

FIG. 1 is a block diagram of a functional configuration of an information management system according to an embodiment. In the present embodiment, although a vehicle is given as an example of a mobile body, the mobile body is not limited to being a ground vehicle. If the techniques disclosed in the present application are applicable, the mobile body may be a vehicle other than a ground vehicle, such as a marine vessel, aircraft, or the like.

As illustrated in FIG. 1, vehicle 100 includes platform 99 that is implemented as software executed using a processor and memory, a plurality of apps 31 that are executed in platform 99, and identification system 98 that is for identifying a driver and is provided separately from platform 99. The information management system is provided in platform 99, and includes API controller 11, API library 12, obtainer 13, and information storage 14. Platform 99 is, for example, integrated in a car navigation system (not illustrated in the figures) and receives operations and the like performed on apps 31 by the driver from the user interface of the car navigation system.

API controller 11 is a processor that calls an application programming interface (API) in response to requests from apps 31, and executes processes in accordance with the API called. Specifically, API controller 11 obtains an API information item on an API scheduled to be called when app 31 calls the API, determines whether the API is capable of being called for the driver currently driving vehicle 100, and then calls only those

APIs determined as APIs capable of being called. Specifically, API controller 11 cooperates with API library 12 and obtainer 13, which will later be described, in order to determine whether an API is capable of being called.

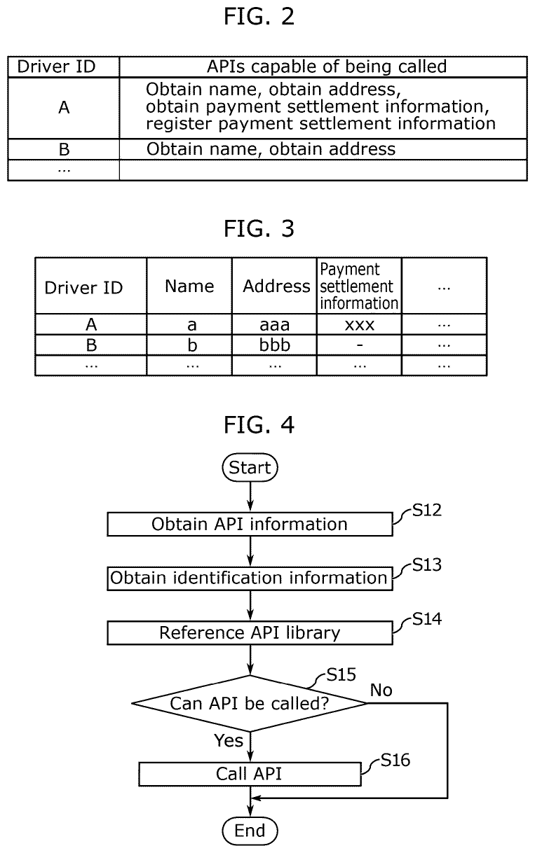

API library 12 is a database provided in vehicle 100 for associating the driver with APIs capable of being called. FIG. 2 is a diagram for describing information stored in an API library according to the embodiment. For example, as illustrated in the figure, in API library 12, a driver ID (an example of an identification information item) for differentiating each driver from a plurality of other drivers is linked to a list of APIs that are set as APIs capable of being called for the driver. For example, for the driver with driver ID “A”, the list of APIs capable of being called includes an API for obtaining a name, an API for obtaining an address, an API for obtaining payment settlement information, and an API for registering payment settlement information, and the like.

Obtainer 13 obtains, as an identification information item, an identification result that identifies the driver operating vehicle 100 from identification system 98 of vehicle 100. Identification information items are exchanged in the form of driver IDs as described above, for example. For example, identification system 98 obtains an image from a camera that is positioned to capture an image of the driver seat of vehicle 100, and performs personal identification, by image recognition, to differentiate the driver seated in the driver seat of vehicle 100 from other drivers. The information processing involved in this identification may be performed with the intervention of an external server or the like. In this manner, obtainer 13 obtains a result of personal identification.

Alternatively, for example, identification system 98 communicates with an identification device that is within a range in which communication with the communication system of vehicle 100 is possible (in other words, inside of the vehicle cabin of vehicle 100), and performs personal identification to differentiate the driver in vehicle 100 from other drivers based on personal information registered in the identification device. In this manner, obtainer 13 may obtain a result of personal identification. It should be noted that the identification device may be a general-purpose information terminal, such as a smartphone, tablet device, or personal computer owned by the driver, or may be a dedicated terminal, such as a smart key or the like that is registered for each individual driver. Additionally, for personal identification, existing personal identification techniques, such as fingerprint authentication, voice authentication, vein authentication, and the like may be used as needed.

Obtainer 13 obtains the driver ID of the driver of vehicle 100 as an identification information item. By referencing API library 12 using the driver ID and the API information item obtained from app 31, API controller 11 determines whether the API related to the API information item is included in the entry for the corresponding driver ID as an API capable of being called. API controller 11 calls APIs and restricts calling of APIs based on this determination result.

It should be noted that API controller 11 can perform such determination for all APIs, or may perform such determination for only those APIs among the APIs that access information stored in information storage 14 that will hereinafter be described.

Information storage 14 stores information items on personal settings that are stored in vehicle 100. FIG. 3 is a diagram for describing information stored in the vehicle according to the embodiment. As illustrated in the figure, vehicle 100 stores driver names, addresses, payment settlement information, and the like, as information items that can be obtained by each app 31. Each app 31 can obtain such information items from information storage 14 by calling an API for obtaining information items.

Hereinafter, an example of operation of the above-mentioned information management system will be described with reference to FIG. 4. FIG. 4 is a flowchart illustrating one example of operation of the information management system according to the embodiment. While each app 31 is running, each app 31 calls a plurality of APIs, and performs each function by the processor executing a process in accordance with the APIs. Here, app 31 transmits an API information item to API controller 11 for each API call request. API controller 11 obtains the API information item (S12), and obtainer 13 is caused to query identification system 98 for an identification information item. In this manner, an identification information item is obtained each time an API call is scheduled, with the obtaining of an API information item acting as a trigger. Obtainer 13 newly obtains the identification information item (S13), and outputs the latest identification information item to API controller 11.

API controller 11 references API library 12 using the API information item obtained and the latest identification information item (S14). In relation to the API information item obtained, API controller 11 determines whether the API scheduled to be called is an API capable of being called (S15). When API controller 11 determines that the API is capable of being called (“Yes” in S15), by calling the API (S16), API controller 11 obtains an information item stored by accessing information storage 14 by the processor executing a process in accordance with the API and outputs the information item to app 31, for example.

On the other hand, when it is determined that the API cannot be called (“No” in S15), execution of the API is prohibited (S16 is skipped). Processing is then terminated. This series of processes is performed each time an API information item is obtained. However, as described earlier, when differentiating between an API for which these processes are to be performed and an API for which these processes are not to be performed, the processes for steps S13 and onward are only performed in cases where an API information item related to an API for which these processes are to be performed is obtained. In other words, a determination as to whether the API related to the API information item obtained is an API for which these processes are to be performed can made after step S12.

Furthermore, once the engine has been started, since there is a high probability that the driver will not change until the engine is stopped, an identification information item need only be obtained a single time after the engine has been started, and subsequently, as the identification information item that has already been obtained may continue to be used until the engine is stopped, the obtaining of an identification information item may be omitted for the second iteration and onward (S13 is skipped). However, to account for cases in which the driver is changed after the engine has been started, when a sensor, such as a seat occupancy sensor or the like, which is capable of detecting the sitting down and standing up of a driver, is provided in the seat in which the driver is seated, an identification information item may once again be obtained exclusively in cases in which it is detected, in cooperation with the sensor, that the driver may have changed (detected to have stood up from the seat). However, it can be assumed that the driver will leave the seat after the engine has been stopped. For this reason, in this example, once an identification information item has been obtained, that identification information item will continue to be used until the driver leaves the seat (or is determined to have left the seat).

As described above, in the information management system according to the embodiment, access to information items stored in vehicle 100 can be managed at the API level (or in other words, in platform 99). Accordingly, even when app 31 is newly installed and used, there is no need for additional settings, and since the APIs capable of being called are managed for each driver, those APIs that are permitted to be called can be used to access the information items stored in vehicle 100. Consequently, the information items can be managed in a more appropriate manner.

### Other Embodiments

Although a control device and the like according to an embodiment of the present disclosure has been described above, the present disclosure is not limited to this exemplary embodiment.

For example, in the above-mentioned embodiment, each element may be configured as dedicated hardware, or may be implemented by executing a software program suitable for each element. The respective elements may be implemented by a program executer such as a CPU or a processor reading and executing a software program recorded on a recording medium such as a hard disk or semiconductor memory.

Furthermore, each element may be a circuit (or an integrated circuit). Such a circuit may be consolidated as a single circuit, and may be configured as individual circuits. Furthermore, such circuits may each be a general-purpose circuit or a dedicated circuit.

Furthermore, general and specific aspects of the present disclosure may be implemented as a system, a device, a method, an integrated circuit, a computer program, or a non-transitory computer-readable recording medium such as a CD-ROM. Furthermore, the present disclosure may be implemented as a system, a device, a method, an integrated circuit, a computer program, or a non-transitory computer-readable recording medium such as a CD-ROM.

Furthermore, in the above-mentioned embodiments, processes to be executed by a certain processor may be performed by another processor. Furthermore, the order of the processes in the operation of the communication system described in the above-mentioned embodiments may be rearranged, and, alternatively, the processes may be performed in parallel.

Forms obtained through various modifications to the foregoing embodiments that can be conceived by those skilled in the art, as well as forms realized by combining elements and functions in the foregoing embodiments without departing from the essence of the present disclosure are included within the scope of the present disclosure.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims is incorporated herein by reference in its entirety: Japanese Patent Application No. 2024-053571 filed on Mar. 28, 2024.

### INDUSTRIAL APPLICABILITY

The present disclosure is applicable in managing information in a mobile body, such as a vehicle or the like.

1. An information management system that manages information stored in a mobile body, the information management system comprising:
an obtainer that obtains an identification information item of a driver operating the mobile body;
a function library that stores, in association with each other, one or more identification information items of one or more drivers and one or more lists of functions that are capable of being called, the one or more identification information items including the identification information item, the one or more drivers including the driver; and
a function controller, wherein
the function controller:
obtains a function information item related to a function for accessing an information item stored in the mobile body, the function being a function scheduled to be called by software executed in the mobile body;
determines whether the function related to the function information item is capable of being called, by referencing the function library using the identification information item of the driver operating the mobile body obtained and the function information item obtained; and
calls the function based on a determination result obtained by the function controller.

2. The information management system according to claim 1, wherein
the identification information item of the driver operating the mobile body is obtained as a result of personal identification using an image obtained capturing the driver.

3. The information management system according to claim 1, wherein
the identification information item of the driver operating the mobile body is obtained as a result of personal identification using communication with an identification device possessed by the driver.

4. The information management system according to claim 1, wherein
a function information item is obtained for each scheduled call of a function by software executed in the mobile body, and
each time a function information item is obtained, the function controller determines whether a function related to the function information item is capable of being called, and calls the function based on a determination result obtained by the function controller.

5. The information management system according to claim 1, wherein
the identification information item of the driver operating the mobile body is obtained for each scheduled call of a function by software executed in the mobile body, and
the function controller references the function library using an identification information item of a driver operating the mobile body that is newly obtained.

6. The information management system according to claim 1, wherein
the identification information item of the driver operating the mobile body is obtained after the mobile body is started, and
the function controller continues to use the identification information item obtained until the driver operating the mobile body leaves a seat.

7. An information management method for managing information stored in a mobile body, the information management method being executed by a computer, the information management method comprising:
obtaining an identification information item of a driver operating the mobile body;
obtaining a function information item related to a function for accessing an information item stored in the mobile body, the function being a function scheduled to be called by software executed in the mobile body;
determining whether the function related to the function information item is capable of being called, by referencing a function library that stores, in association with each other, one or more identification information items of one or more drivers and one or more lists of functions that are capable of being called, using the identification information item of the driver operating the mobile body obtained and the function information item obtained, the one or more identification information items including the identification information item, the one or more drivers including the driver; and
calling the function based on a result of the determining.

8. A non-transitory computer-readable recording medium having recorded thereon a program for causing a computer to execute the information management method according to claim 7.
